(19) United States
(12) Patent Application Publication
(10) Pub. No.: US 2003/0137948 A1
(43) Pub. Date: Jul. 24, 2003

(54) Retransmission control in wireless packet data networks

(76) Inventors: Sridhar Komandur, Richardson, TX (US); Janet H. Lind, Plano, TX (US); Jogen K. Pathak, Irving, TX (US); Rangaprasad Govindarajan, Plano, TX (US); Shridhar Krishnamurthy, Coppell, TX (US)

Correspondence Address: R. Scott Rhoades, Strasburger & Price, L.L.P., Suite 4300, 901 Main Street, Dallas, TX, 75202-3794, US

(21) Appl. No.: 10/289,659

(22) Filed: Nov. 7, 2002

Related U.S. Application Data
(63) Continuation-in-part of application No. 09/884,663, filed on Jun. 19, 2001.
(60) Provisional application No. 60/345,035, filed on Nov. 9, 2001.
(60) Provisional application No. 60/356,380, filed on Feb. 11, 2002.

(51) Int. Cl. H04B 7/14

(52) U.S. Cl. 370/315

(57) ABSTRACT

A system, method, and apparatus for transmitting packet data over a wireless network to a mobile station is presented herein. Packet data are received at a wireless content switch that is part of the wireless data network. The wireless content switch is equipped to detect lost packets, lost acknowledgments, and take appropriate remedial action, without invoking the congestion control and avoidance mechanisms of the transmission control protocol.

### CROSS-REFERENCE TO RELATED APPLICATIONS

This application claims the priority benefit of U.S. Provisional Applications for Patent, Serial No. 60/345,035, entitled “Weighted Wireless Early Detection,” filed Nov. 9, 2001, and Ser. No. 60/356,380, entitled “Wireless Optimized TCP,” filed Feb. 11, 2002 and is a continuation-in-part of U.S. patent application Ser. No. 09/884,663 entitled “Packet Retransmission in a Wireless Packet Data Networks,” filed on Jun. 19, 2001, all of which are hereby incorporated by reference for all purposes.

### STATEMENT REGARDING FEDERALLY SPONSORED RESEARCH/DEVELOPMENT

Not Applicable

### FIELD

The present application is related to wireless packet data networks, and more particularly to retransmission control in wireless packet data networks.

### BACKGROUND

Wireless networks are increasingly being used for accessing the Internet. Wireless packet data protocols such as Universal Mobile Telecommunications System (UMTS), General Packet Radio Service (GPRS) and EDGE were developed to facilitate the transmission of data packets over the wireless network.

The Internet is a global network connecting computers from government agencies, educational institutions, the military, and businesses from around the world. Data is transmitted over the Internet using data packets. The data packets are sent from a sender to a recipient over any one of a number of network connections between the sender and recipient. Unlike a switched network, no dedicated connection between the sender and recipient is established. In contrast, the packets are sent from the sender with an address associated with the recipient, such as an Internet Protocol address (IP address) over any one of a number of available paths between the sender and recipient.

Due to the lack of a dedicated path between the recipient and the sender, the requisite time of transmission can vary from packet to packet. Additionally, during periods of high congestion, data packets can also be dropped by an intermediate router. The foregoing considerations necessitate a means of providing the sender with a confirmation that the transmitted data packets are received. The Transmission Control Protocol (TCP) provides for the use of acknowledgment messages between the recipient and the sender, responsive to receipt of a data packet.

TCP initially causes the transmission rate to ramp-up in a sliding window at the beginning of a packet flow, which is called the slow-start mode. After reaching a threshold on the sliding window size, TCP slowly increases the transmission rate in a linear fashion, which is called the congestion-avoidance mode. The rate is continuously increased until there is a loss or time-out of the packet receipt acknowledgment message. TCP then “backs off”, decreasing the transmission window size, and then retransmits the lost packets in the proper order at a significantly slower rate. TCP assumes that packet losses are due to congestion and implements a slow start upon packet loss.

As noted above, TCP assumes that lost packets are due to network congestion. In wired networks, which are characterized by low bit error rates, the assumption is accurate. However, wireless networks are characterized by comparatively higher bit error rates, limited bandwidth, radio interference, and intermittent hand-offs, that are different from wired networks. The higher bit error rates, radio interference, and intermittent handoffs cause more packet losses. The assumption that packet losses are due to congestion becomes inaccurate.

In the presence of the high bit error rates and intermittent connectivity characteristic of wireless links, TCP reacts to packet losses in the same manner as in the wired environment. The transmission window size is lowered before retransmitting packets and congestion control and avoidance mechanisms are invoked. The foregoing measures result in an unnecessary reduction in the wireless link's bandwidth utilization, thereby causing a significant degradation in performance in the form of poor throughput and very high interactive delays.

Modifications to the TCP protocol are often infeasible because of the necessary changes that would have to be made to the large number of existing servers and clients. A number of proposals have been made to alleviate the aforementioned degradation in performance, such as using a split connection, fast retransmit, and caching packets at the base station.

The Indirect-TCP (I-TCP) uses a split connection approach that involves splitting a TCP connection between a fixed and mobile host into two separate connections at the base station. The first connection is a TCP connection between the base station and the fixed host, while the second is between the base station and the mobile station. Because the second connection is a one-hop wireless link, a more optimized wireless link-specific protocol is used. Although I-TCP advantageously separates flow and congestion control of the wireless link from that of the fixed network, there are also a number of drawbacks. For example, I-TCP acknowledgments and semantics are not end-to-end. Additionally, applications running on the mobile station have to be relinked with the I-TCP library and need to use special I-TCP socket system calls. As well, packets need to go through the TCP protocol stack and incur the associated overhead four times—once at the sender, twice at the base station, and once at the receiver.

The fast retransmit approach addresses the issue of faster response to packet loss (instead of waiting for timeout) and quick rampup of the sliding window. Problems associated with handoffs are mitigated by having the mobile station send a certain threshold number of duplicate acknowledgments to the sender, causing the sender to immediately reduce the window size and retransmit packets starting from the first missing packet. The main drawback of the fast retransmit approach is that the sliding window is cut in half.

Balakrishnan, et. al., in “Improving TCP/IP Performance over Wireless Network”, proceedings 1st ACM International Conference on Mobile Computing and Networking, November 1995, propose a transport protocol wherein packets are cached at the base station. Lost packets are retransmitted locally over the wireless link, thereby hiding packet loss over the wireless link from the fixed host. However, the transport protocol requires modifications of the network layer software at the base station and the mobile station.

Accordingly, it would be desirable to alleviate the performance degradation brought on by TCP congestion control and avoidance mechanisms in response to lost data packets over wireless links in a seamless manner with minimal modifications to the preexisting infrastructure.

### SUMMARY

Presented herein is a system and method for transmitting packet data over a wireless network to a mobile station. A wireless content switch is interposed between the wireline network and the mobile station. The wireless content switch monitors the transmissions and detects lost data packets and lost acknowledgments based on the received data packets and acknowledgments.

The wireless content switch stores the data packets that are in route to the mobile station. When a packet loss is detected, the wireless content switch takes remedial actions without invoking the congestion control and avoidance schemes of the Transmission Control Protocol (TCP), and therefore avoiding the performance degradation associated therewith.

### BRIEF DESCRIPTION OF THE DRAWINGS

FIG. 1 is a block diagram of an exemplary data communication system;

FIG. 1A is a block diagram of an exemplary wireless content switch;

FIG. 2 is a flow diagram describing the operation of the wireless content switch;

FIG. 2A is a flow diagram describing the determination of whether a received packet is in sequential order by the wireless content switch;

FIG. 3 is a signal flow diagram describing the operation of the system, wherein data packets are transmitted from content source to mobile station;

FIG. 4 is a signal flow diagram describing the operation of the system wherein a data packet is lost in the wired network;

FIG. 5 is a signal flow diagram describing the operation of the system wherein a data packet is lost in the wireless air interface;

FIG. 6 is a signal flow diagram describing the operation of the system wherein a lower order data packet is received;

FIG. 6A is a signal flow diagram describing the operation of the system wherein the radio link is down;

FIG. 6B is a signal flow diagram describing the operation of the system wherein the radio link is found to be operational;

FIG. 6C is a signal flow diagram describing the operation of the wireless content switch wherein an acknowledgment is received;

FIG. 7 is a flow diagram describing the “eat the packet” function during retransmission; and

FIG. 8 is a flow diagram describing the “drain the packet” function during retransmission.

### DETAILED DESCRIPTION OF THE DRAWINGS

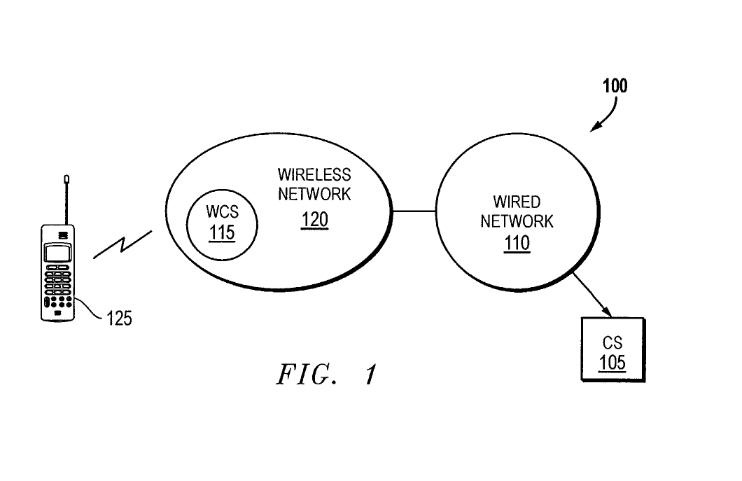

Referring now to FIG. 1, there is illustrated a conceptual diagram of a communication system, referenced generally by the numeric designation 100, for sending data packets from content source 105 to a mobile station 125. The content source 105 is a server providing information which can comprise, for example, a web server, email server, for server, database server, streaming audio/video server, or an application server.

Information from the content source 105 is transmitted in the form of numbered data packets over a wired network 110, wherein each data packet is associated with a packet number. The wired network 110 is a packet data wireline communication system which can comprise, for example, a local area network, a wide area network, or the Internet. The wired network 110 transmits the data packets to a wireless network 120 associated with the mobile station 125 via a wireless-content switch 115.

The wireless network 120 comprises any communication network which can transmit packet data over a wireless air interface. For example, the wireless network 120 can comprise cellular data networks, such as the Code-Division Multiple Access (CDMA), the Global System for Mobile Communications (GSM) or the Personal Communication System (PCS), equipped to transmit packet data in accordance with the Universal Mobile Telecommunications System (UMTS), General Packet Radio Service (GPRS) or EDGE protocols. The wireless network 120 transmits the packet data over the wireless air interface to the mobile station 125.

A wireless content switch 115 receives packets in wireless network data formats (for example, GPRS Tunneling Protocol (GTP) format packet data) and can determine additional processing that may be required based upon the mobile station 125, and the type of content in the packet, priority data, quality of service data, multicasting functionality, or other suitable functions. In one disclosed embodiment, the wireless content switch is an Intelligent Packet Control Node (IPCN) developed and manufactured by Cyneta Networks, Inc.

The wired network 110 uses the Transmission Control Protocol (TCP) which provides for the use of acknowledgment messages to the content source 105, responsive to receipt of the data packet. Upon receipt of the data packets, acknowledgments are sent which indicate the last contiguous data packet received. For example, wherein data packets P(l) . . . P(N) are received, followed by P(N+2) . . . P(N+T), wherein T is a predetermined threshold, an acknowledgment indicating P(N) will be sent responsive to receipt of P(N+T). The acknowledgment indicating P(N) after transmission of P(N+T) is considered duplicative acknowledgment. As noted above, TCP assumes that lost packets are due to network congestion. In the wired network 110, which is characterized by low bit error rates, the assumption is accurate. However, the air interface between the mobile station 125 and the wireless network 120 is characterized by comparatively higher bit error rates, limited bandwidth, radio interference, and intermittent hand-offs. The higher bit error rates, radio interference, and intermittent hand-offs cause more packet losses. The assumption that packet losses are due to congestion becomes inaccurate.

The wireless content switch 115 receives the data packets sent from the content source 105 and forwards the data packet to the mobile station 125. Prior to forwarding the packet to the mobile station 125, the wireless content switch 115 stores the data packet. When the mobile station 125 receives data packets, the acknowledgments transmitted from the mobile station 125 are received by the wireless content switch 115.

As noted above, the acknowledgments transmitted from the mobile station 125 are indicative of the last contiguous packet received, thereat. Therefore, the receipt by the wireless content switch 115 of duplicative acknowledgments are indicative of lost packets between the wireless air interface and the mobile station 125.

Responsive thereto, the wireless content switch 115 can retransmit the missing data packet to the mobile station 125 or execute “eat the packet” or “drain the packet” functions which are disclosed herein. Upon receipt of the missing packet, the mobile station 125 transmits an acknowledgment to the wireless content switch 115. The wireless content switch 115 then forwards the acknowledgment to the content source 105. In the foregoing manner, TCP congestion control and avoidance is prevented from occurring due to the loss of a data packet over the wireless air interface.

Referring now to FIG. 1A, there is illustrated a block diagram of an exemplary wireless content switch 115. The wireless content switch 115 includes any number of upstream ports 150a and downstream ports 150b. The upstream ports 150a facilitate connection of the wireless content switch 115 towards the content source 105 via a trunk line, such as, for example, a T1, El, or an Ethernet connection, to name a few. Connection of the wireless content switch 115 towards the content source 105 via the upstream port 150a permits, at the upstream port 150a, receipt and transmission of data packets, acknowledgments, and other signals to and from content source 105.

Similarly, the downstream ports 150b facilitate connection of the wireless content switch 115 towards the mobile station 125 via a trunk line. Connection of the wireless content switch 115 towards the mobile station 125 via the downstream port 150b permits, at the downstream port 150b, receipt and transmission of data packets, acknowledgments, and other signals to and from content source 105.

The wireless content switch 115 also includes memory 155 wherein packets received from the upstream port 150a are stored. In one embodiment, the memory 155 can comprise Shared Dynamic Random Access Memory (SDRAM). Packets received from upstream port 150a are transmitted along a bus 160 for storage into the memory 155. Data packets stored in the memory 155 are transmitted by forwarding the data packet from the memory 155 to the downstream port 150b via bus 160.

The memory 155 can also store executable instructions for execution by a processing unit 165. Until required by the processing unit 165, the instructions may be stored in another memory, for example in a hard disk drive 170, or in a removable memory such as an optical disk 175 for eventual use in a compact disk read only memory (CD-ROM) drive 180 or a floppy disk 185 for eventual use in a floppy disk drive 190.

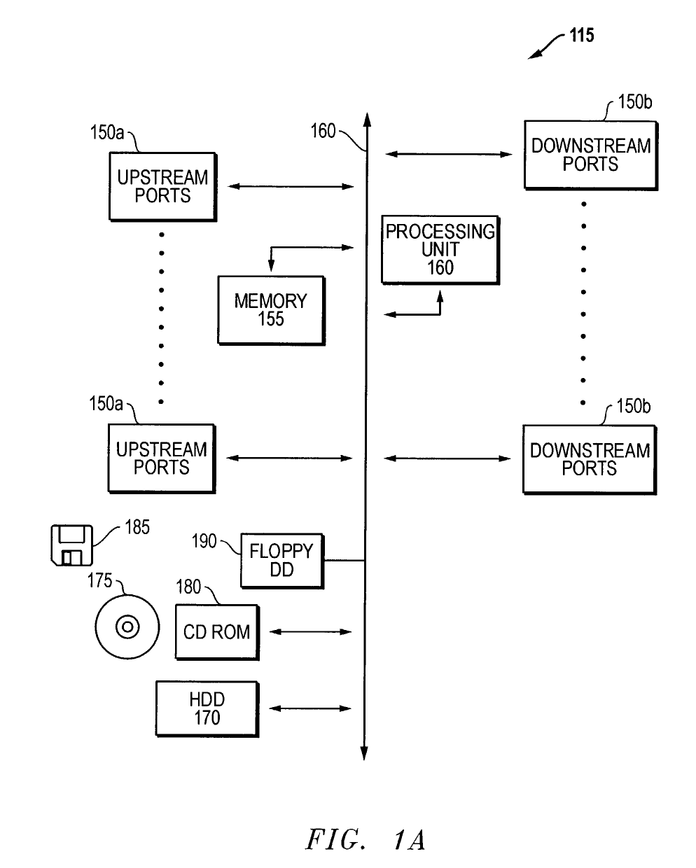

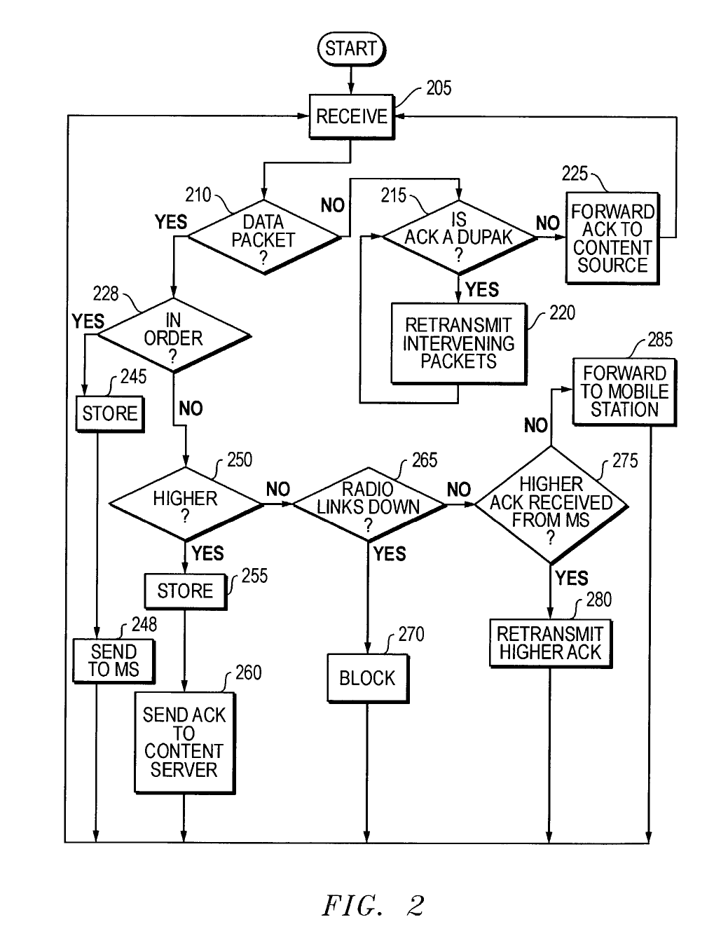

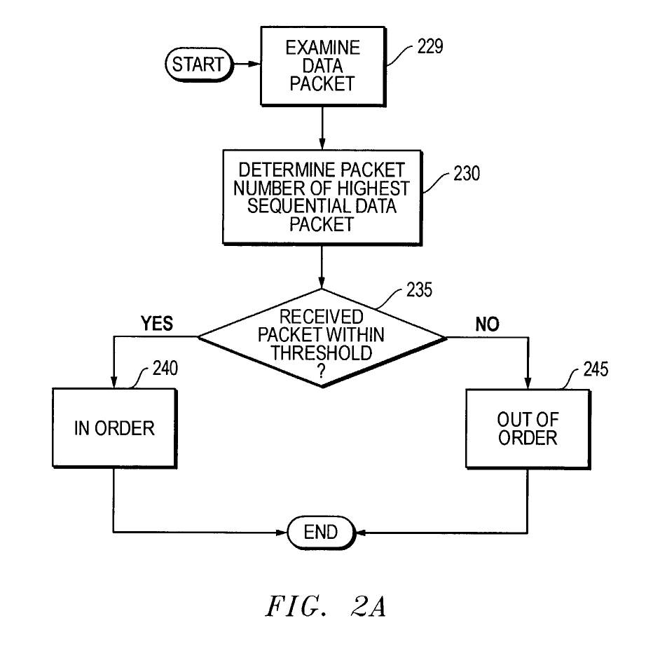

Referring now to FIG. 2, there is illustrated a flow diagram describing the operation of the wireless content switch, responsive to receiving a signal at a port 150 (step 205). At step 210, a determination is made whether the signal is an acknowledgment or a data packet. Wherein the received signal is an acknowledgment during step 210, a determination is made whether the acknowledgment is a duplicated acknowledgment or not (step 215).

Wherein the acknowledgment, e.g., A(I) was received before (known as a “duplicate acknowledgment”), the foregoing condition is indicative that data packets transmitted to the mobile station 125 after data packet P(I) were lost. Therefore, the packets after P(I) must be retransmitted. Accordingly, wherein the acknowledgment is a duplicate acknowledgment during step 215, the wireless content switch 115 retransmits (step 220) the intervening packets. As noted above, the wireless content switch 115 stores data packets in memory 155, prior to transmission to the wireless data network 120. Therefore, the wireless content switch can retrieve the intervening data packets from memory 155 and retransmit them via downstream port 150b. Wherein the acknowledgment is not a duplicate acknowledgment during step 215, the acknowledgment is forwarded to the content source 105 via upstream port 150a (step 225). Wherein the signal received during step 210 is a data packet, a determination is made whether the packet is in sequential order (step 228).

In another embodiment, after receipt of a duplicate acknowledgment signifying that the data packet transmitted to the mobile station 125 is lost, a determination of whether the lost data packet was a one packet scenario or a last packet scenario is made. A one packet scenario occurs when the session includes only one packet. The last packet scenario occurs when the session has only one packet left for transmission. If the duplicate acknowledgment is received and the one packet or last packet scenario occurs, then the “eat the packet” function may be implemented.

In another exemplary embodiment, if the mobile station becomes unreachable, the wireless content switch 115 stores the data packet in memory 155, prior to transmission to the mobile station 125. The wireless content switch 115 delays retransmission of the data packets until the reachability of the mobile station is determined. Once the mobile station is reachable, then a determination is made as to whether the retransmission timeout has occurred. If a retransmission timeout has occurred, then the “drain the packet” function is implemented.

Referring now to FIG. 2A, there is illustrated a flow diagram describing the operation of the wireless content switch 115 in determining whether the received data packet is in sequential order. At step 229, the received data packet is examined. By examining the data packet, the wireless content switch 115 can determine a packet number associated with the received data packet. The packet number is related to the sequential order of the data packet in a sequence of data packets. The wireless content switch 115 then determines (step 230) the-packet number of the highest sequential data packet and compares (step 235) the packet number to the received data packet number.

It is noted that the Internet does not always deliver data packets in sequence. While a given packet, K+1, may be received prior to packet K, the foregoing condition is not necessarily due to the fact that packet K is lost or even excessively delayed. However, wherein a packet K+T is received prior to packet K, wherein T represents a predetermined threshold, there is a great likelihood that packet K is lost or excessively delayed between the content source 105 and the Internet content switch 115. Accordingly, during step 235, wherein the packet number of the received data packet is within a predetermined threshold, T, of the packet number of highest sequential data packet, a determination (step 240) is made that the packet is received in order. However, wherein the packet number of the received data packet is beyond the predetermined threshold, T, a determination (step 245) is made that the-data packet is received out of order.

Referring again to FIG. 2, wherein the data packet is in sequential order, the data packet is stored by the wireless content switch 115 in memory 155 (step 246) and sent to the mobile station 125 via downstream port 150b (step 248). Wherein the data packet is not in sequential order, a determination is made whether the data packet is in higher sequential order or in lower sequential order (step 250). Wherein the data packet is in higher sequential order during step 250, the foregoing is indicative of data packets lost between the content source 105 and the wireless content switch 115. Therefore, the intervening data packets must be retransmitted to the wireless content source 115. Accordingly, the wireless content switch 115 stores (step 255) the data packets in memory 155 and transmits an acknowledgment via upstream port 150a (step 260) to the content source 105. The acknowledgment transmitted to the content source 105 indicates the last contiguous data packet received, thereby causing the content source 105 to retransmit the missing data packets.

Wherein the received data packets are in lower sequential order, the foregoing is indicative that the content source 105 has timed out prior to receiving appropriate acknowledgments. The wireless content switch 115 examines the wireless radio link conditions and determines (step 265) whether the radio link is down. Whether the radio link is down or not can be determined by, for example, using a handshake signal. Wherein the radio link is down, the received data packets are blocked (step 270).

Wherein the radio link is not down during step 265, a determination is made whether the wireless content switch 115 has received an acknowledgment of a higher packet number (step 275). Wherein an acknowledgment of a higher data packet has been received, the foregoing is indicative that an acknowledgment of a lower number data packet from the mobile station 125 has been lost. Accordingly, the acknowledgment of the higher data packet is retransmitted to the content source 105 (step 280). Wherein an acknowledgment of a higher data packet number has not been received, the data packets are retransmitted from memory 155 (step 285) to the mobile station 125.

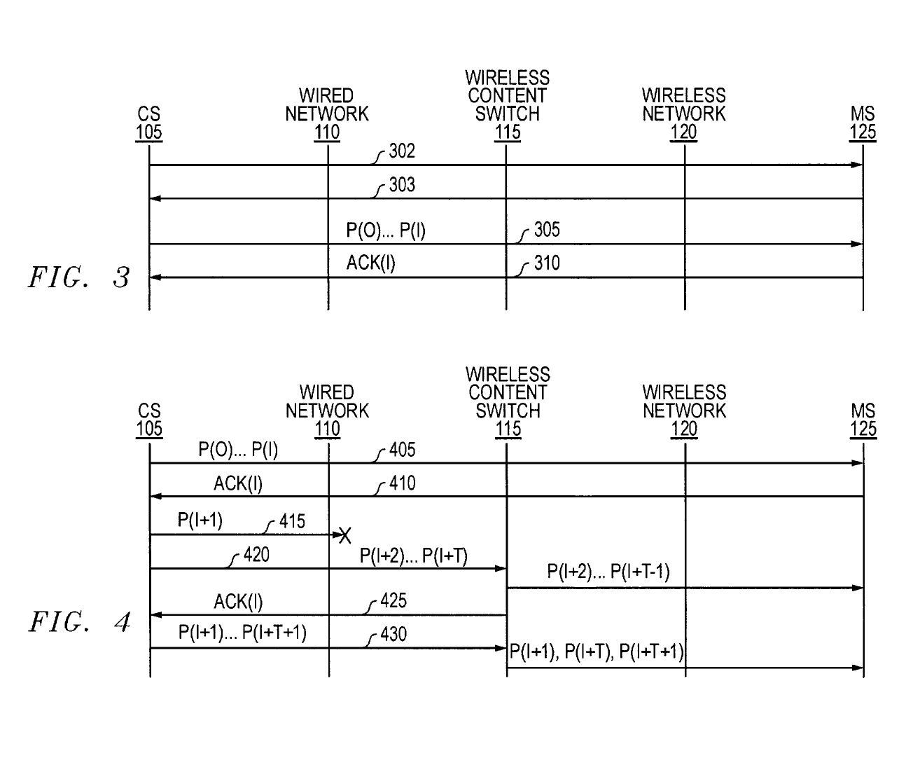

The operation of the wireless content switch 115 is now described in certain exemplary scenarios. Referring now to FIG. 3, there is illustrated a signal flow diagram describing acknowledgment of sequential packets wherein the packets are received in order. Initially, the content source 105 transmits a setup signal 302 to the mobile station 125. The mobile station 125 then transmits a signal 303 containing a mobile station 125 identifier.

The content source 105 transmits information in the form of sequential data packets, wherein each data packet is associated with a particular sequential number, e.g., P(0) . . . P(I). The data packets are transmitted from the content sources 105 via the wired network 110 (signal 305), wireless content switch 115, and wireless network 120 to the mobile station 125. Upon receipt of a particular data packet, an acknowledgment is transmitted from the mobile station 125 which indicates the last contiguous packet. Therefore, wherein data packets P(0) . . . P(I) are received at the mobile station 125, responsive to receipt of data packet P(I), the mobile station transmits an acknowledgment, ACK(I) (signal 310).

Referring now to FIG. 4, there is illustrated a signal flow diagram describing the operation of the system, wherein a data packet is lost in the wired network 110. The content source 105 transmits data packets P(0) . . . P(I) to the mobile station 125 (signals 405), and the mobile station 125 transmits acknowledgments (signals 410)to the content source 105. The content source 105 transmits data packets P(I+1) (signal 415) and P(I+2) . . . P(I+T) (signal 420) to wireless content switch 115 via upstream port 150a, wherein data packet P(I+1) is lost in the wired network 110. Responsive to receipt of data packet P(I+2) . . . P(I+T) at the wireless content switch 115, the wireless content switch 115 detects that data packet P(I+l) is lost. The wireless content switch 115 transmits an acknowledgment ACK(I) (signal 425) via upstream port 150a indicating that data packet P(I) was the last contiguous packet received.

Additionally, the wireless content switch 115, and withholds transmission of data packet P(I+T) towards the mobile station 125. Responsive to receiving ACK(I), the content source 105, retransmits data packet P(I) with data packet P(I+T+1) (signal 430). Upon receipt of data packets P(I), P(I+T+1), the wireless content switch transmits data packets P(I+1), P(I+T), and P(I+T+1) (signals 435) to the mobile station 125 via downstream port 150a. Upon receipt of data packets P(I+1), P(I+2), and P(I+3), the mobile station 125 transmits acknowledgment (signal 440), ACK(I+3) indicating that every packet until P(I+3) has been received.

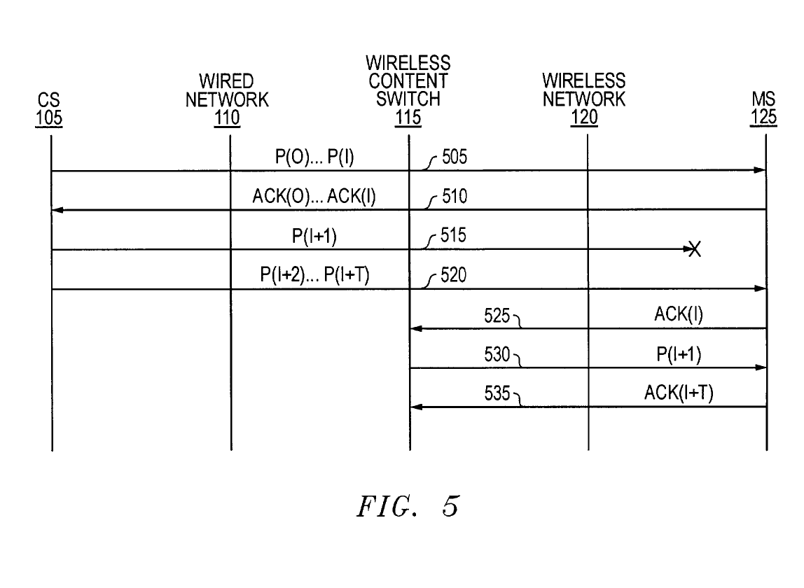

Referring now to FIG. 5, there is illustrated a signal flow diagram describing the operation of the system wherein a data packet is lost in wireless air interface between the wireless network 120 and the mobile station 125. The content source 105 transmits data packets P(0) . . . P(I) to the mobile station 125 (signals 505), and the mobile station 125 transmits acknowledgments (signals 510) ACK(0) . . . ACK(I) to the content source 105. The content source 105 proceeds to transmit data packet P(I+1) (signal 515) towards mobile station 125.

Data packet P(I+1) is received, stored in memory 155, and transmitted by wireless switch 115 towards mobile station 125. However, the data packet P(I+1) is lost in transmission between the mobile station 125 and the wireless network 120. Content server 105 proceeds to transmit data packets P(I+2) . . . P(I+T) to the mobile station 125 (signal 520). Upon receipt of data packet P(I+T), the mobile station 125 transmits an acknowledgment. However, because P(I+1) was not received by the mobile station 125, the last contiguous data packet is P(I). Accordingly, mobile station 125 transmits ACK(I) (signal 525).

The ACK(I) is received by the wireless content switch 115 at downstream port 150b. Responsive thereto, the wireless content switch 115 detects that data packet P(I+1) is stored at the wireless switch and was not received by the mobile station 125. Accordingly, the wireless content switch 115 retransmits the data packet P(I+1) from memory 155 to mobile station 125 via downstream port 150b (signal 530). Additionally, the wireless content switch 115 withholds transmission of ACK(I) to the content server 105, thereby preventing invocation of congestion control and avoidance mechanisms. When the mobile station 125 receives data packet P(I+1), the mobile station 125 transmits an acknowledgment ACK(I+T) (signal 535) to the wireless content switch 115 which is forwarded to the content source 105.

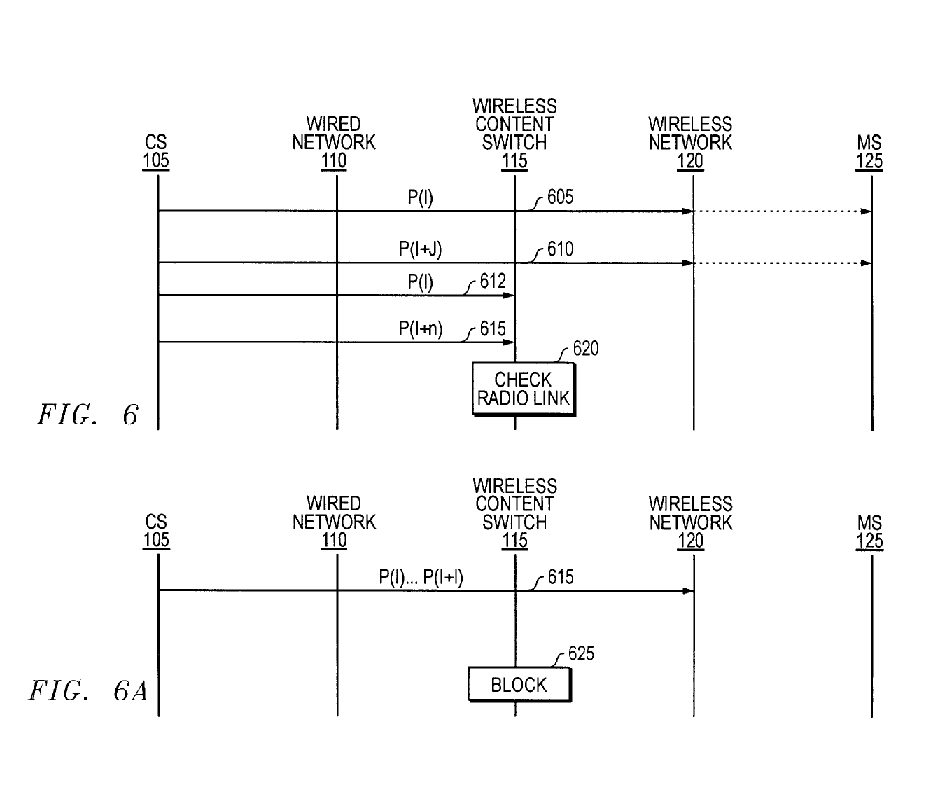

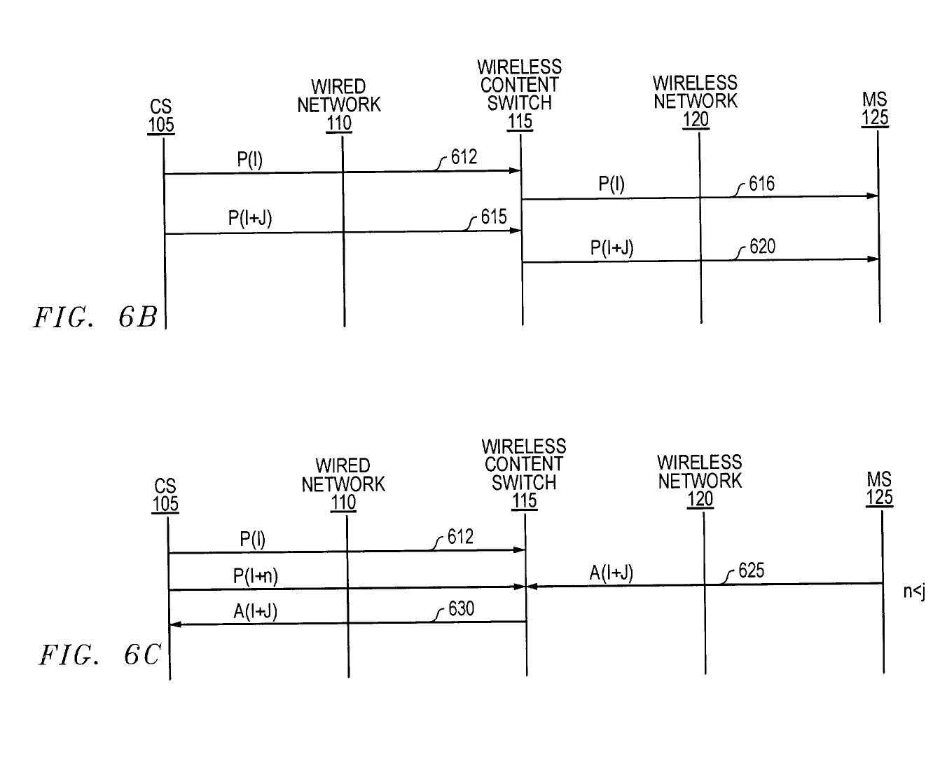

Referring now to FIG. 6, there is illustrated a signal flow diagram describing the operation of the wireless content switch 115, wherein lower ordered data packets are received by the wireless content switch 115 via upstream port 150a. Data packet P(I) through P(I+J) are transmitted from the content source 105 towards the mobile station 125 (signals 605, 610). After transmission of data packets P(I) to P(I+J) towards the mobile station 125, data packets P(I) . . . P(I+n), where n<=J, are again received at the wireless content switch (signals 612, 615) via the upstream port 105a.

The foregoing condition is indicative of a time out at the content source 105. The time out can either be caused by lost acknowledgments, a down radio connection between the wireless network 120 and the mobile station 125, or loss of data packets over the wireless network 120. Accordingly, the wireless content switch 115 examines the radio link and determines whether the radio link is up (action 620).

Referring now to FIG. 6A, there is illustrated a signal flow diagram describing the operation of the wireless content switch 115, wherein the wireless content switch 115 has detected that the radio link between the wireless network 120 and the mobile station 125 is down. Responsive to receipt of data packets P(I) . . . P(I+J) (signals 612, 615), the wireless content switch blocks (action 625) forward transmission of the data packets to the mobile station 125.

Referring now to FIG. 6B, there is illustrated a signal flow diagram describing the operation of the wireless content switch 115, wherein the radio link is determined to be operational. The wireless content switch 115 receives the data packets P(I) . . . P(I+J) (signal 612, 615) via upstream port 150a. The absence of any acknowledgment from the mobile station 125 is indicative of lost packets, P(I) . . . P(I+J) during the initial transmission (signals 605, 610). Accordingly, the wireless content switch 115 proceeds to retransmit the data packets P(I) . . . P(I+J) from memory 155 to the mobile station 125 (signals 616, 620) via downstream port 150b.

Referring now to FIG. 6C, there is illustrated a signal flow diagram describing the operation of the wireless content switch 115, wherein the radio link is determined to be operational. The wireless content switch 115 receives the data packets P(I) . . . P(I+n) via upstream port 150a (signals 612, 615). However, the wireless content switch 115 receives an acknowledgment, ACK(I+J), (signal 625) indicating receipt of each data packet until data packet P(I+J) via downstream port 150b. The foregoing is indicative of a lost acknowledgment. Accordingly, the wireless content switch 115 retransmits the acknowledgment (signal 630) via upstream port 150a to the content source 105. Transmission of the acknowledgment ACK(I+J) causes the content source to terminate transmission of the data packets prior to P(I+J).

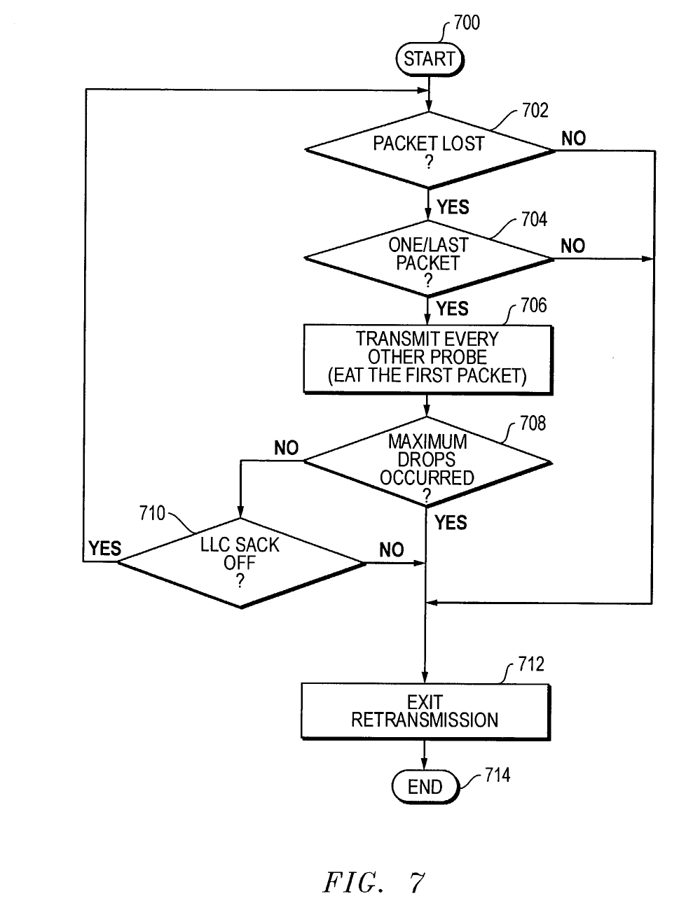

Referring now to FIG. 7, the flow diagram of the “Eat The Packet” (ETP) function during retransmission is shown. Retransmission control reduces unnecessary retransmission of data packets over the air interface. The flow diagram begins with start 700. Next in step 702, the determination of whether a packet has been lost in the transmission to the mobile station has occurred. The packet is lost if no acknowledgment signal is received from the mobile station for the last transmitted packet or if a duplicate acknowledged signal has been received for a previously transmitted packet. Conditions which are indicative of data packet losses can include, for example, detection of deterioration in the radio frequency wireless link, or detection of excessive buffer memory usage by a wireless client. If no packet is lost as determined in step 702, then the retransmission function exits at step 712 and ends with step 714. If a packet is determined to be lost in step 702, then whether the packet is a one packet transmission or a last packet transmission is determined. The one packet or last packet determination is made in step 704 by comparing the amount of data present in the data packet with the maximum amount of data that can be transmitted. If the amount of data is less than the maximum amount, then the situation is a one packet/last packet scenario. However, alternate implementations of determining the one packet or last packet scenario are available and can be implemented without detracting from the spirit of the invention. If the lost packet is not a one packet or last packet as determined in step 704, then the process continues with step 712 and the retransmission function is exited. If the lost packet is the one packet or last packet as determined in step 704, the wireless content switch (WCS) transmits every other probe received from the wired network to the mobile station. The first probe received from the wired network is discarded with the second probe being transmitted to the mobile station. By transmitting every other probe, the traffic over the degraded air interface is reduced. In most situations, the lost packet will eventually reach the mobile station and thus any excess probes and/or retransmissions of the one packet or last packet is unnecessary. Next, in step 708 the number of probe drops or discards is evaluated against the maximum drops allowable. If the number of probe drops is less than the maximum drops, then the process continues to step 710 where the determination of the Logical Link Control (LLC) selective acknowledgment (SACK) is observed. If the LLC SACK is off, then the process returns to step 702 and evaluation of whether the packet is lost occurs. If the maximum drops has been met as determined in step 708 or if the LLC SACK is not off as determined in step 710, then the process continues with step 712 and the retransmission function is exited. The function then ends with step 714.

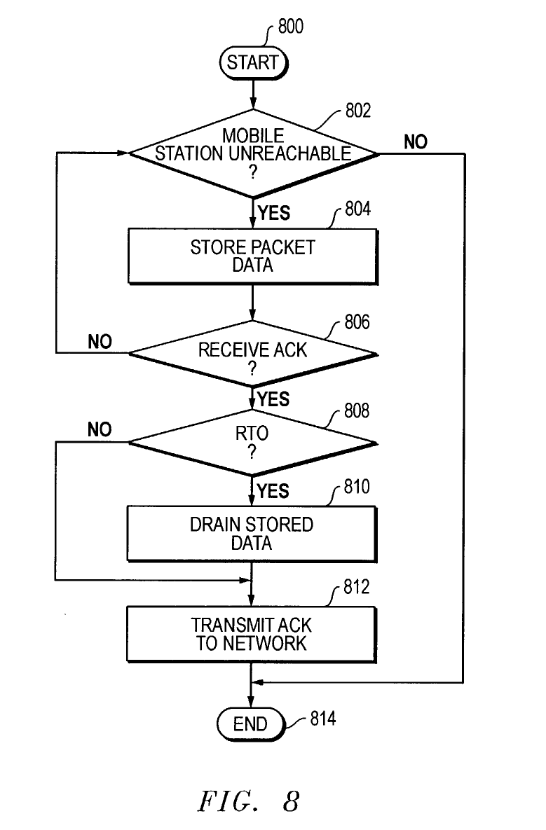

Referring now to FIG. 8, the “Drain The Packet” (DTP) function during retransmission is shown. The function begins with start 800. Next, the determination of whether the mobile station is reachable is made in step 802. If the mobile station is reachable, then the function continues with step 814 end. If the mobile station is unreachable, then the packet data received from the wired network is stored in step 804. Next, in step 806, whether an acknowledgment has been received from the mobile station on the last transmitted packet data is determined. If no acknowledgment has been received, then the process returns to step 802 and the packet data is continued to be stored in step 804. If an acknowledgment has been received in step 806, then a determination of whether the retransmission timeout has occurred in step 808. If the retransmission timeout has occurred in step 808, then the stored packet data is drained. If the retransmission timeout has not occurred, then the process continues with step 812 and the acknowledgment is transmitted to the wired network. The packet data stored in the wireless content switch is drained at step 810 because once a retransmission timeout has occurred, the wired network will retransmit the unacknowledged packet data regardless of the data stored at the wireless content switch. If the stored packet data is not drained, then this data will be sent to the mobile station along with the retransmission from the wired network causing excess transmission. If the retransmission timeout has not occurred, then the stored packet data is transmitted to the mobile station with the acknowledgment being retransmitted to the wired network. If the retransmission timeout has not occurred, then the wired network will not retransmit the stored packet data. The process ends with step 814.

Although the foregoing detailed description describes certain embodiments with a degree of specificity, it should be noted that the foregoing embodiments are by way of example, and are subject to modifications, substitutions, or alterations without departing from the spirit or scope of the invention. For example, one embodiment can be implemented as sets of instructions resident in a memory, such as memory 155, 170, 175, or 185. Those skilled in the art will recognize that physical storage of instructions physically changes the medium upon which it is stored electronically, magnetically, or chemically so that the medium carries computer readable information. Accordingly, the invention is only limited by the following claims, and equivalents thereof.

What is claimed is:

1. A wireless content switch for transmitting data packets, said wireless content switch comprising:
an upstream port for receiving one or more data packets;
a downstream port for transmitting the one or more data packets to a mobile station;
at least one processing unit coupled to the upstream and down stream ports;
memory for storing the one or more data packets responsive to receiving the data packets and for retrieving the one or more data packets for retransmission; and
retransmission code stored in the memory, the retransmission code, when executed, performing the steps of:
receiving at least one probe at the upstream port;
determining if a packet is lost;
determining if lost transmitted packet is a one packet/last packet;
if the lost transmitted packet is a one packet/last packet, transmitting every other probe to the mobile station via the downstream port; and
determine if acknowledgment received.

2. The wireless content switch of claim 1, further comprising retransmission code, when executed, performing the steps of:
determining if a maximum number of probe drops has occurred;
if the maximum number of probe drops has occurred, ending retransmission code execution.

3. The wireless content switch of claim 2 wherein the maximum number of probe drops is predetermined.

4. The wireless content switch of claim 1, wherein the step of determining if the packet is lost includes determining if an acknowledgment has been received.

5. The wireless content switch of claim 1, wherein the step of determining if the packet is lost includes determining if duplicate acknowledgments have been received.

6. The wireless content switch of claim 1, further comprising retransmission code, when executed, performing the steps of:
determining if selective acknowledgment of the logical link control is off;
if the selective acknowledgment of the logical link control is off, transmitting every other probe to the mobile station via the downstream port.

7. The wireless content switch of claim 1 wherein the step of determining if the lost packet is a one packet/last packet includes determining if the packet size is less than the maximum size.

8. The wireless content switch of claim 1 wherein the step of transmitting every other probe includes discarding the first probe.

9. In a packet data network comprising a wired network, a wireless network, a method for transmitting data packets to a mobile station, said method comprising:
receiving one or more data packets from the wired network;
storing the one or more data packets until determination that the one or more data packets are not received at a mobile station;
receiving at least one probe;
determining if a packet is lost;
determining if lost transmitted packet is a one packet/last packet;
if the lost transmitted packet is a one packet/last packet, transmitting every other probe to the mobile station; and
determine if acknowledgment received.

10. The method of claim 9, further comprising the steps of:
determining if a maximum number of probe drops has occurred;
if the maximum number of probe drops has occurred, ending retransmission code execution.

11. The method of claim 10 wherein the maximum number of probe drops is predetermined.

12. The method of claim 9, wherein the step of determining if the packet is lost includes determining if an acknowledgment has been received.

13. The method of claim 9, wherein the step of determining if the packet is lost includes determining if duplicate acknowledgments have been received.

14. The method of claim 9, further comprising retransmission code, when executed, performing the steps of:
determining if selective acknowledgment of the logical link control is off;
if the selective acknowledgment of the logical link control is off, transmitting every other probe to the mobile station via the downstream port.

15. The method of claim 9 wherein the wherein the step of determining if the lost packet is a one packet/last packet includes determining if the packet size is less than the maximum size.

16. The method of claim 9 wherein the wherein the step of transmitting every other probe includes discarding the first probe.

17. A wireless content switch for transmitting data packets, said wireless content switch comprising:
an upstream port for receiving one or more data packets;
a downstream port for transmitting the one or more data packets to a mobile station;
memory for storing the one or more data packets responsive to receiving the data packets and for retrieving the one or more data packets for retransmission; and
retransmission code stored in the memory, the retransmission code, when executed, performing the steps of:
determining if the mobile station is unreachable;
if the mobile station is unreachable, storing one or more data packets;
determining if an acknowledgement is received from mobile station;
if the acknowledgement is received determining if the retransmission has timed out;
if the retransmission has timed out, draining the stored one or more data packets; and
transmitting the acknowledgment to the network.

18. The wireless content switch of claim 17, wherein the step of determining if the mobile station is unreachable includes determining no acknowledgment received after a predetermined time after transmission.

19. The wireless content switch of claim 17, wherein the step of determining if an acknowledgement is received from mobile station includes determining if the acknowledgement received from the last transmitted packet.

20. The wireless content switch of claim 17, wherein the step of determining if the retransmission has timed out includes an evaluation over a predetermined time out period.

21. The wireless content switch of claim 17, wherein the step of draining the data packets includes discarding the data packets.

22. In a packet data network comprising a wired network, a wireless network, a method for transmitting data packets to a mobile station, said method comprising:
receiving one or more data packets;
transmitting the one or more data packets to a mobile station;
storing the one or more data packets responsive to receiving the data packets and for retrieving the one or more data packets for retransmission;
determining if the mobile station is unreachable;
if the mobile station is unreachable, storing one or more data packets;
determining if an acknowledgement is received from mobile station;
if the acknowledgement is received determining if the retransmission has timed out;
if the retransmission has timed out, draining the stored one or more data packets; and
transmitting the acknowledgment to the network.

23. The method of claim 22 wherein the step of determining if the mobile station is unreachable includes determining no acknowledgment received after a predetermined time after transmission.

24. The method of claim 22 wherein the step of determining if an acknowledgement is received from mobile station includes determining if the acknowledgement received from the last transmitted packet.

25. The method of claim 22 wherein the step of determining if the retransmission has timed out includes an evaluation over a predetermined time out period.

26. The method of claim 22 wherein the step of draining the data packets includes discarding the data packets.
